(19) United States
(12) Patent Application Publication
(10) Pub. No.: US 2015/0288125 A1
(43) Pub. Date: Oct. 8, 2015

(54) HYDRAULICALLY ACTUATED TOOL AND VALVE ASSEMBLY THEREFOR

(71) Applicant: LEGEND CORPORATE SERVICES PTY LTD, Hendon (AU)

(72) Inventor: Michael Sneath, Bayswater North (AU)

(21) Appl. No.: 14/438,612

(22) PCT Filed: Oct. 9, 2013
(86) PCT No.: PCT/AU2013/001164

§ 371 Date: Apr. 24, 2015

(30) Foreign Application Priority Data
Oct. 26, 2012 (AU) 2012904740

(51) Int. Cl. H01R 43/042; F15B 11/08; B25B 27/14

(52) U.S. Cl. CPC H01R 43/0428; B25B 27/146; F15B 11/08; F15B 2211/20576

(57) ABSTRACT

A shuttle valve assembly for an hydraulically actuated tool has a primary chamber with a primary inlet port located at an upstream end thereof for communicating with an hydraulic fluid supply. The primary inlet port defines an inlet valve seat with an inlet stop located downstream. An inlet valve member is displaceable along an inlet valve path between a closed position sealingly engaging the inlet valve seat to at least substantially prevent flow of hydraulic fluid through the primary inlet port and an open position engaging the inlet stop and allowing flow. A primary outlet port is located at a downstream end of the primary chamber for communicating the primary chamber with an actuable member of the tool. The primary outlet port defines an outlet valve seat with an outlet stop located downstream.

### FIELD OF THE INVENTION

The present invention relates to an hydraulically actuated tool, such as an hydraulic crimping tool, and a valve assembly for such an hydraulically actuated tool.

### BACKGROUND OF THE INVENTION

Hydraulic crimping tools are used in the electrical industry for crimping connectors and splices to cables. Typically an end of a cable to be spliced or connected is positioned in a suitable splice or connector, and a crimping tool is used to crush or crimp the splice or connector onto the cable, thereby causing the splice or connector to be crushed onto the cable such that it grippingly engages with it and provides an electrical coupling.

The splice or connector has to have sufficient strength to resist the tensile forces created by the combined weight of the cables as they hang, and the splice or connector has to be crushed against the cable with sufficient crushing force to ensure a proper electrical connection. The connector or splice needs to be strong enough to be suitable for this type of application. It therefore requires significant crushing force to be able to deform the connector or splicer onto the cable.

Hydraulic crimping tools are able to provide the crushing force required to deform the connector or splice. These are typically either manually or electrically operated. For many industrial applications, such as electrical utility applications, the pressure that the jaws need to apply to the splice or connector can be as high as 10,000 psi (about 70 mPa) or greater.

A crimping operation using an hydraulically actuated crimping tool involves placing the splice or connector to be crimped on to a cable, then positioning the crimping tool in the appropriate location on the splice or connector, and then pulling a trigger that causes a power supply, such as a battery, to energise an electric motor which operates on at least one pump to cause hydraulic fluid to flow from a reservoir through at least one valve and to operate a set of moveable jaws which provide the crushing force needed to execute the crimp. It is common for one of the jaws to be fixed, and the other jaw to be movable toward it under hydraulic pressure.

Hydraulic crimping tools are typically relatively bulky to enable them to crimp connectors or splices on industrial electrical cabling, which require a large jaw size and generation of large crimping forces. Crimping tools are also often used in difficult working conditions which may either be cramped conditions or elevated conditions above the ground on a ladder, scissor lift, cherrypicker or the like. Improved efficiency of the hydraulic actuated tool, providing a reduced period for the crimping operation, and/or reduced bulk of the hydraulic crimping tool would thus be desirable.

### OBJECT OF THE INVENTION

It is an object of the present invention to at least substantially satisfy at least one of the above desires, or at least to provide a useful alternative to currently available hydraulically actuated tools.

### SUMMARY OF THE INVENTION

In a first aspect, the present invention provides a shuttle valve assembly for an hydraulically actuated tool, said shuttle valve assembly comprising:

a primary chamber;

a primary inlet port located at an upstream end of said primary chamber for communicating said primary chamber with an hydraulic fluid supply, said primary inlet port defining an inlet valve seat at a downstream end thereof;

an inlet stop located in said primary chamber downstream of said inlet valve seat;

an inlet valve member located between said inlet valve seat and said inlet stop, said inlet valve member being displaceable along an inlet valve path between a closed position sealingly engaging said inlet valve seat to at least substantially prevent flow of hydraulic fluid through said primary inlet port and an open position engaging said inlet stop and allowing flow of hydraulic fluid through said primary inlet port and around said inlet valve member through said primary chamber;

a primary outlet port located at a downstream end of said primary chamber for communicating said primary chamber with an actuable member of the tool, said primary outlet port defining an outlet valve seat at a downstream end thereof;

an outlet stop located downstream of said outlet valve seat;

an outlet valve member located between said outlet valve seat and said outlet stop, said outlet valve member being displaceable along an outlet valve path between a closed position sealingly engaging said outlet valve seat to at least substantially prevent flow of hydraulic fluid through said primary outlet port and an open position engaging said outlet stop and allowing flow of hydraulic fluid through said primary outlet port and around said outlet valve member towards the actuable member; and

a charging port located between said primary inlet port and said primary outlet port for communicating said primary chamber with an hydraulic pump.

Typically, said inlet valve member and said outlet valve member are each in the form of a ball.

In a preferred form, said inlet valve path has a length of less than 2 mm. Typically, said inlet valve path length is approximately 1 mm.

In a preferred form, said outlet valve path has a length of less than 2 mm. Typically, said outlet valve path length is approximately 1 mm.

In a preferred form, said valve assembly further comprises:

a secondary chamber communicating with said primary chamber via said primary outlet port; and

a secondary outlet port, located at a downstream end of said secondary chamber, communicating said secondary chamber with the actuable member;

wherein said outlet stop and said outlet valve member are located in said secondary chamber.

Typically, said valve assembly further comprises an inlet valve spring, extending between said inlet stop and said inlet valve member, biasing said inlet valve member towards said inlet valve seat.

Typically, said inlet valve spring is mounted about said inlet stop.

Typically, said valve assembly further comprises a valve outlet spring, extending between said outlet stop and said outlet valve member, biasing said outlet valve member towards said outlet valve seat.

Typically, said outlet valve spring is mounted about said outlet stop.

Typically, said primary chamber is cylindrical. Typically, said primary chamber has a diameter of between 1.1 and 1.5 times the diameter of said inlet valve member. In the particular arrangement depicted, the primary chamber has a diameter of 5.5 mm and the inlet valve member has a diameter of 4.5 mm.

In a preferred form, said inlet valve path has a length of between 0.5 times and 2.0 times the difference in the diameters of said primary chamber and said inlet valve member. Typically, said inlet valve path length is approximately equal to said difference.

Typically, said secondary chamber is cylindrical. Typically, said secondary chamber has a diameter of between 1.1 and 1.5 times the diameter of said secondary valve member. In the particular arrangement depicted, the secondary chamber has a diameter of 5.5 mm and the secondary valve member has a diameter of 4.5 mm.

In a preferred form, said outlet valve path has a length of between 0.5 times and 2.0 times the difference in the diameters of said secondary chamber and said outlet valve member. Typically, said outlet valve path length is approximately equal to said difference.

In a preferred form, said valve assembly comprises a valve body defining said primary and secondary chambers, said valve body being configured to be housed within a cylindrical cavity defined in a body of the hydraulically actuated tool.

In a preferred form, said valve body comprises a primary valve cartridge defining said primary chamber and a secondary valve cartridge defining said secondary chamber. Typically, said secondary cartridge defines said primary chamber outlet.

In a second aspect, the present invention provides an hydraulically actuated tool comprising:

a body;

a shuttle valve assembly as defined above located in said body;

an hydraulic fluid supply communicating with said primary inlet port;

a head assembly having an actuable member communicating with said primary outlet port; and

an hydraulic pump communicating with said charging port.

In a third aspect, the present invention provides an hydraulically actuated tool comprising:
a) an hydraulic fluid supply;
b) a first pump operable in reciprocating suction and discharge cycles, said first pump having:
   i) a first piston chamber;
   ii) a second piston chamber;
   iii) a first piston assembly having a first piston mounted for reciprocating motion within said first piston chamber and a second piston mounted for reciprocating motion within said second piston chamber in unison with said first piston during said suction and discharge cycles of said first pump;
c) a second pump operable in reciprocating suction and discharge cycles, said second pump having:
   i) a third piston chamber; and
   ii) a second piston assembly having a third piston mounted for reciprocating motion within said third piston chamber during said suction and discharge cycles of said second pump;
d) a drive motor operable to drive said first, second and third pistons;
e) a head chamber;
an actuable member adapted to be actuated by pressure within said head chamber;
g) a first valve assembly operatively associated with said first piston such that, during an initial phase of operation of said tool, said first piston draws hydraulic fluid from said hydraulic fluid supply during said suction cycle of said first pump and drives hydraulic fluid into said head chamber during said discharge cycle of said first pump;
h) a second valve assembly operatively associated with said second piston such that said second piston draws hydraulic fluid from said hydraulic fluid supply during said suction cycle of said first pump and drives hydraulic fluid into said head chamber during said discharge cycle of said first pump;
i) a third valve assembly operatively associated with said third piston such that said third piston draws hydraulic fluid from said hydraulic fluid supply during said suction cycle of said second pump and drives hydraulic fluid into said head chamber during said discharge cycle of said second pump;
j) a low pressure relief valve adapted to communicate said first piston chamber with said hydraulic fluid supply upon pressure within said first valve assembly reaching a predetermined threshold pressure, thereby ending said initial phase of operation;

wherein said first piston chamber has a larger effective cross-sectional area than an effective cross-sectional area of each of said second and third piston chambers.

Typically, said first and second pumps are adapted to operate out of phase in opposing cycles.

In a preferred form, at least one of said valve assemblies is a shuttle valve assembly as defined above.

Preferably, each of said valve assemblies is a shuttle valve assembly as defined above.

In a preferred form, said effective cross-sectional area of said second piston chamber is substantially equal to said effective cross-sectional area of said third piston chamber.

In one form, said effective cross-sectional area of said first piston chamber is at least four times said effective cross-sectional area of said third piston chamber.

Typically, said first piston chamber and said second piston chamber are together defined by a first piston mounting cavity formed in said body.

In a preferred embodiment:

said first piston comprises a first piston base and an annular first piston body extending from said first piston base; and

said second piston comprises a second piston base received in said recess and a cylindrical piston body extending from said second piston base into said second piston chamber.

Typically, said first pump further comprises a spring bearing against said second piston base.

Typically, said tool further comprises a cam shaft assembly comprising:

a rotatable shaft driveable by said drive motor;

a first cam lobe mounted on said shaft and engaging a cam follower face of said first pump to drive said first and second pistons; and

a second cam lobe mounted on said shaft and engaging a cam follower face of said second piston for driving said second piston.

In a preferred form, said tool is a crimping tool.

### BRIEF DESCRIPTION OF THE DRAWINGS

A preferred embodiment of the present invention will now be described, by way of an example only, with reference to the accompanying drawings wherein:

FIG. 1 is a perspective view of an hydraulic crimping tool;

FIG. 2 is an exploded perspective view of the hydraulic crimping tool of FIG. 1;

FIG. 3 is an enlarged exploded perspective view of the body assembly of the hydraulic crimping tool of FIG. 1;

FIG. 4 is a cross-sectional view of the first piston assembly of the hydraulic crimping tool of FIG. 1, mounted in the body block;

FIG. 5 is a cross-sectional view of the second piston assembly of the hydraulic crimping tool of FIG. 1, mounted in the body block;

FIG. 6 is a front perspective view of a shuttle valve assembly of the hydraulic crimping tool of FIG. 1;

FIG. 7 is a rear perspective view of the shuttle valve assembly of FIG. 6;

FIG. 8 is a cross-sectional view of the shuttle valve assembly of FIG. 6;

FIG. 9 is a schematic view of the hydraulic crimping tool on FIG. 1 at commencement of a crimping operation;

FIG. 10 is a schematic view of the hydraulic crimping tool of FIG. 1 at completion of a crimping operation;

### DETAILED DESCRIPTION

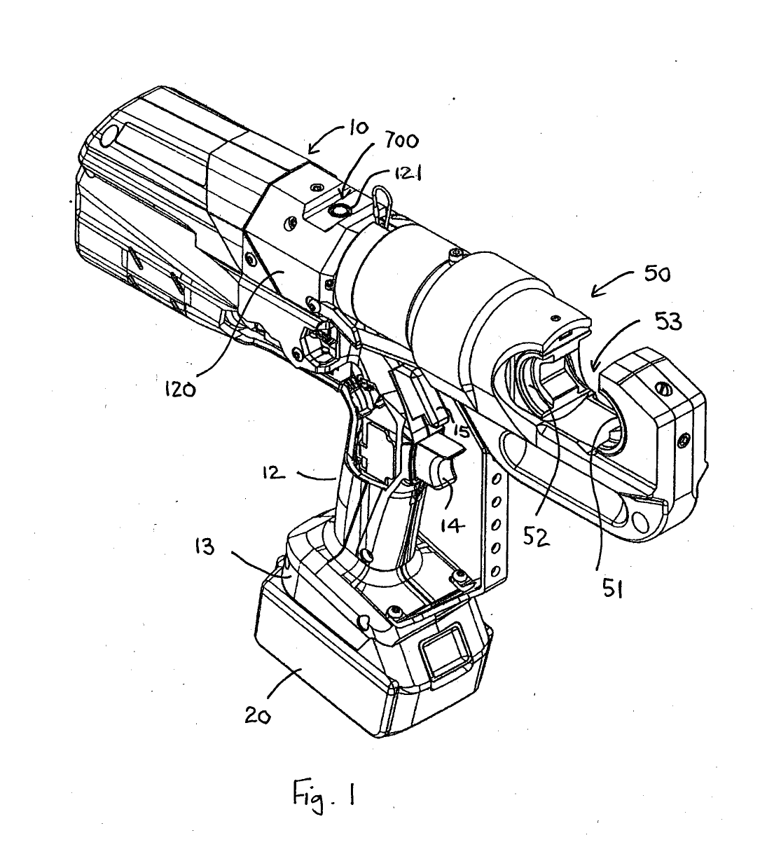

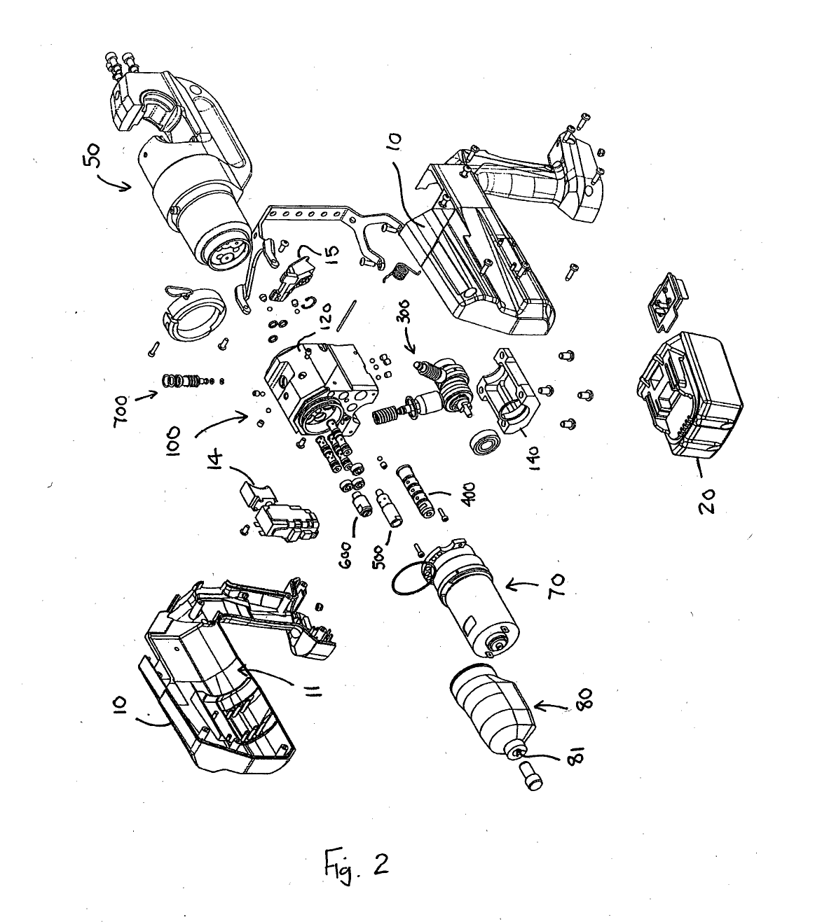

FIGS. 1 and 2 of the accompanying drawings depict an hydraulically actuated tool, in the form of an hydraulic crimping tool. The crimping tool has a two-part casing 10 defining a housing 11 for receipt of various functional components of the tool, as will be described in detail below, and an operator handle 12 depending from the housing 11. The base 13 of the handle 12 is configured to receive a battery pack 20 to electrically power the tool. An operating trigger 14 is mounted on the front of the handle 12. The tool has a head assembly 50 having first and second opposing jaws 51, 52 with a recess 53 defined therebetween for receipt of a connector or splice to be crimped. The first jaw 51 is fixed whilst the second jaw 52 is an actuable member that, in operation, is displaced towards the first jaw 51 under pressure to crimp the connector or splice between the first and second jaws 51, 52.

Referring specifically to FIG. 2, within the housing 11 is mounted a body assembly 100, a motor and gearbox assembly 70 and a bladder 80 defining an hydraulic fluid supply 81.

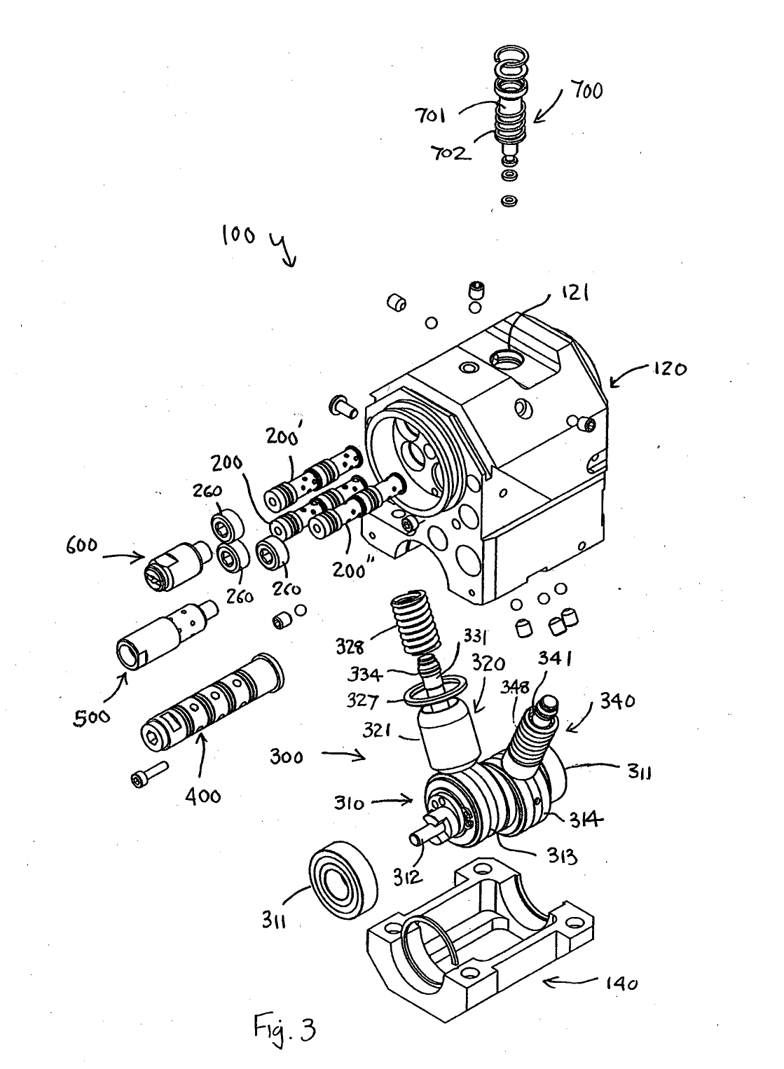

The body assembly 100 is depicted in greater detail in FIG. 3. The body assembly 100 comprises a body block 120, a body base 140, first, second and third shuttle valve assemblies 200, 200′, 200″ mounted in the body block 120, a pump assembly 300 mounted between the body block 120 and body base 140, a head pressure return valve assembly 400 mounted in the body block 120, a high pressure relief valve assembly 500 mounted in the body block 120 and a low pressure relief valve assembly 600, also mounted in the body block 120. An indicator assembly 700 is mounted in the top of the body block 120. The indicator assembly 700 has an indicator body 701 that projects through an opening 121 in the top of the body block 120, as best depicted in FIG. 1. The indictor body 701 is biased to a retracted position by way of a spring 702 mounted on the indicator body 701.

The pump assembly 300 comprises a cam shaft assembly 310, that is mounted between the body block 120 and body base 140 by way of a pair of bearings 311, and first and second piston assemblies 320, 340 respectively which extend into the body block 120. The cam shaft assembly 310 comprises a cam shaft that is in the form of a crankshaft 312 and that is rotatably driven by way of the motor and gearbox assembly 70, and a pair of offset roller bearings that act as first and second cam lobes 313, 314 that drive the first and second piston assemblies 320, 340 respectively as the crankshaft 312 rotates. The first and second cam lobes 313, 314 are here offset by 180 degrees such that the first and second piston assemblies 320, 340 are driven in opposing phases.

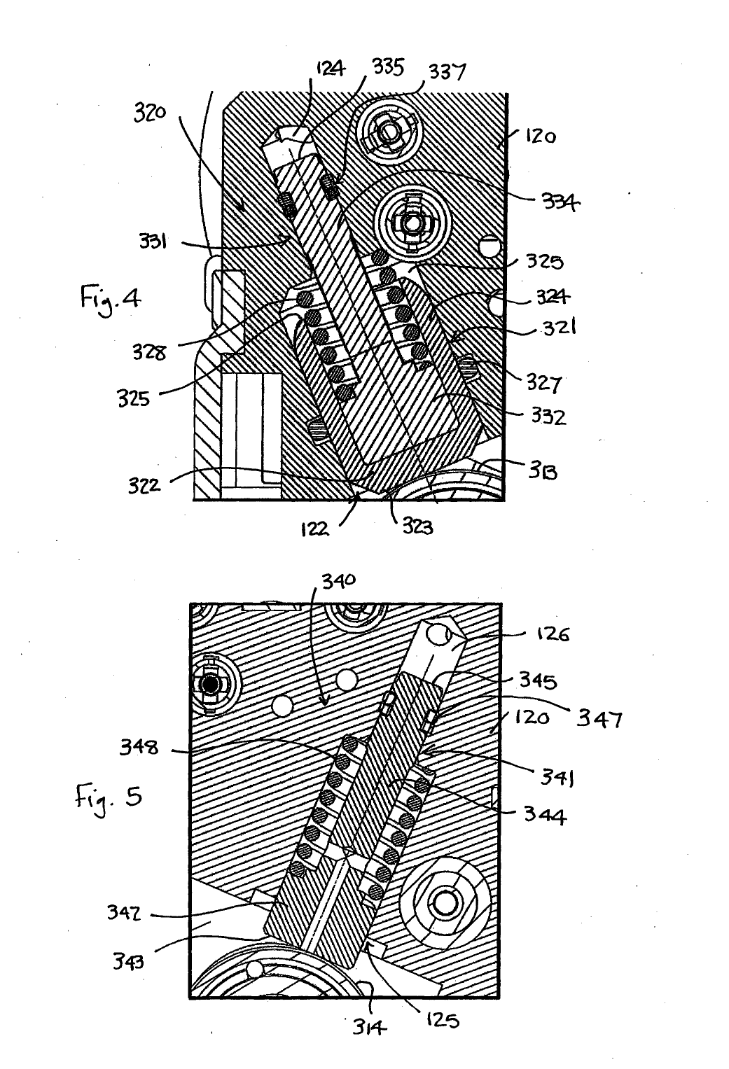

The first piston assembly 320 is depicted in FIGS. 3 and 4. The first piston assembly 320 is of a dual piston configuration, comprising a first piston 321, a second piston 331 and a first spring 328. The first piston 321 has a cylindrical first piston base 322 defining a first cam follower face 323 which engages the first cam lobe 313. The first piston 321 further comprises an annular first piston body 324 extending from the first piston base 322 and defining an annular first piston body face 325. An annular first seal 327 is mounted on the first piston body 324. The second piston 331 has a cylindrical second piston base 332 received in the recess defined by the first piston body 324 and engaging the first piston base 322. The second piston 331 further comprises a cylindrical second piston body 334 extending from the second piston base 332 and defining a second piston body face 335. The first spring 328 is a compression spring and, as depicted in FIGS. 4 and 5, is mounted on the second piston body 334. An annular seal and back up ring arrangement 337 is mounted on the second piston body 334. The first piston assembly 320 is mounted in a first piston mounting cavity 122 formed in the lower face of the body block 120. The first piston mounting cavity 122 has a larger diameter lower region defining a first piston chamber 123 and a smaller diameter upper region defining a second piston chamber 124. The first piston chamber 123 is sized to receive the first piston 321 with the first seal 327 sealing between the first piston body 324 and the wall of the first piston chamber 123, preventing any hydraulic fluid from leaking out of the first piston mounting cavity 122. The second piston chamber 124 is sized to receive the second piston body 334, with the seal 337 sealing between the second piston body 334 and the wall of the second piston chamber 124 to prevent hydraulic fluid from leaking out of the second piston chamber 124. The first spring 328 extends between an annular shoulder defined by the second piston base 332 to an annular shoulder defined by the top wall of the first piston chamber 123. The first spring 328 biases the first piston assembly 320 towards the cam shaft assembly 310, maintaining engagement of the first cam follower face 323 with the first cam lobe 313. The effective cross sectional area of the first piston chamber 123, which is defined by the full cross-sectional area of the first piston chamber 123 minus the cross-sectional area of the second piston body 334 extending through the first piston chamber 123 into the second piston chamber 124, is greater than the effective cross-sectional area of the second piston chamber 124, which is defined by the actual full cross-sectional area of the second piston chamber 124. As will be discussed below, this provides that the first piston 321 acts as a high-volume, low pressure pump, whilst the second piston 331 acts as a low volume, high pressure pump. In the particular arrangement depicted, the first piston chamber 123 has a diameter of approximately 19 mm and the second piston chamber 124 has a diameter of approximately 7 mm. The first piston chamber 123 thus has an effective cross-sectional area of 245 mm² and the second piston chamber 124 has an effective cross-sectional area of approximately 39 mm². The effective cross-sectional area of the first piston chamber 123 is thus approximately 6.4 times that of the second piston chamber 124. Generally, it is preferred that the effective cross-sectional area of the first piston chamber 123 is at least four times that of the second piston chamber 124. The stroke of the first and second pistons 321, 331 is approximately 5 mm.

The second piston assembly 340 is depicted in FIGS. 3 and 5. The second piston assembly 340 is of a single piston configuration, comprising a third piston 341 and a second spring 348. The third piston 341 has a cylindrical third piston base 342 defining a second cam follower face 343 which engages the second cam lobe 314. The third piston 341 further comprises a cylindrical third piston body 344 extending from the third piston base 342 and defining a third piston body face 345. An annular seal and back up ring arrangement 347 is mounted on the third piston body 344. The third spring 348 is a compression spring and is mounted on the third piston body 344. The second piston assembly 340 is mounted in a second piston mounting cavity 125 formed in the lower face of the body block 120. The second piston mounting cavity 125 has a larger diameter lower region and a smaller diameter upper region defining a third piston chamber 126. The third piston chamber 126 is sized to receive the third piston 341 with the seal 347 sealing between the third piston body 344 and the wall of the third piston chamber 126, preventing any hydraulic fluid from leaking out of the third piston chamber 126. The second spring 348 extends between an annular shoulder defined by the third piston base 342 and an annular shoulder defined at the top of the lower region of the second piston mounting cavity 125. The second spring 348 biases the second piston assembly 340 towards the cam shaft assembly 310, maintaining engagement of the second cam follower face 343 with the second cam lobe 314. The effective cross-sectional area of the third piston chamber 126 is identical to that of the second piston chamber 124, having a diameter of approximately 7 mm and effective cross-sectional area of approximately 39 mm². The third piston 341 again has a stroke of approximately 5 mm.

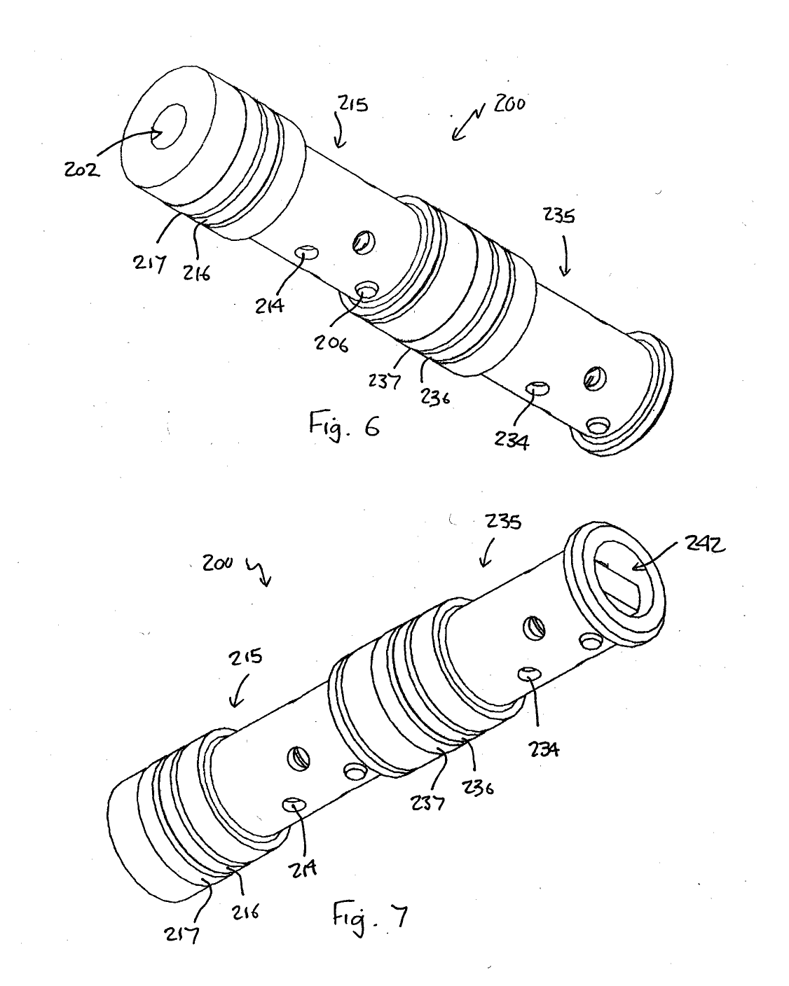

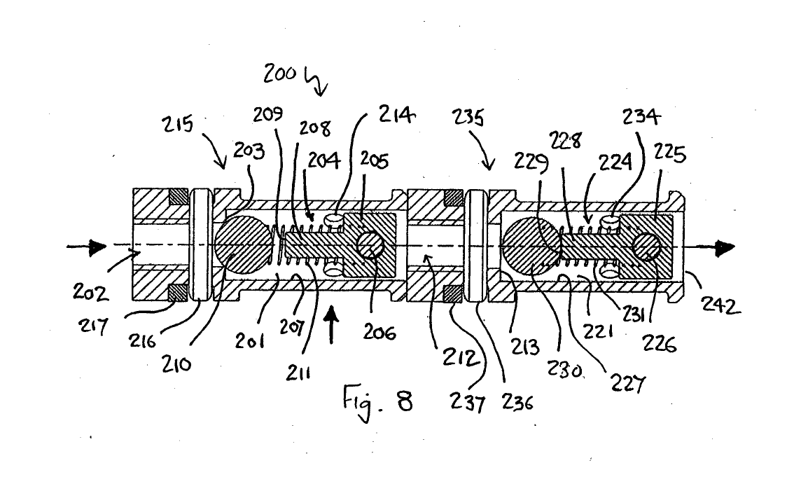

The configuration of each of the shuttle valve assemblies 200, 200′, 200″ is identical and is depicted in further detail in FIGS. 6 through 8. The shuttle valve assembly 200 has a primary chamber 201 with a primary inlet port. 202 located at an upstream end of the primary chamber 201. The primary inlet port 202 communicates the primary chamber 201 with the hydraulic fluid supply 81. The primary inlet port 202 defines an annular inlet seat 203 at the downstream end of the primary inlet port 202. An inlet stop 204 is located in the primary chamber 201 downstream of the inlet valve seat 203. The inlet stop 204 has a cylindrical inlet stop base 205 that is fixed in position within the primary chamber 201 by way of a shaft 206 extending laterally through the inlet stop base 205 and through opposed sides of the wall 207 of the primary chamber 201. The inlet stop base 205 is sized to allow hydraulic fluid to pass between it and the wall 207 of the primary chamber 201. The inlet stop 204 has a cylindrical inlet stop stalk 208 extending upstream from the inlet stop base 205 and defining an inlet stop face 209.

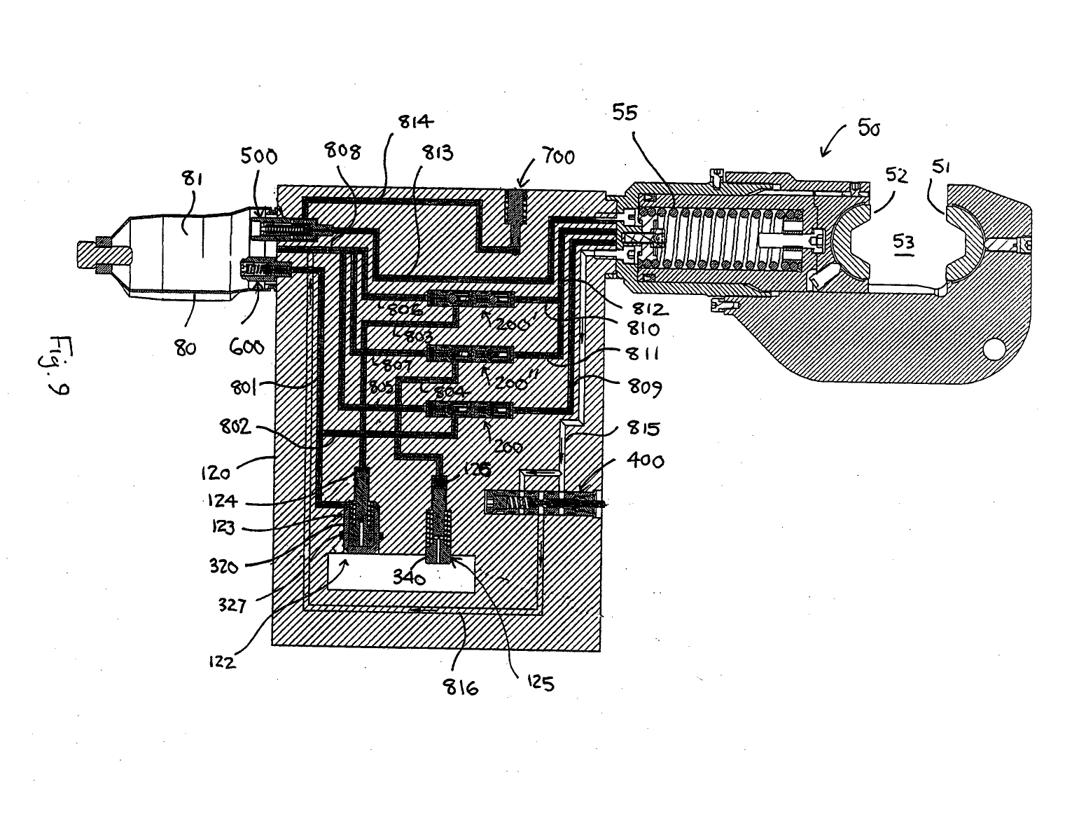

An inlet valve member 210 is located between the inlet valve seat 203 and the inlet stop 204. The inlet valve member 210 is displaceable along an inlet valve path between a closed position (depicted in FIG. 8), sealingly engaging the inlet valve seat 203 to at least substantially prevent the flow of hydraulic fluid through the primary inlet port 202, and an open position engaging the inlet stop face 209. In the open position, the inlet valve member 210 allows the flow of hydraulic fluid through the primary inlet port 202. The inlet valve member 210 is also sized to allow a gap between the inlet valve member 210 and the wall 207 of the primary chamber 201, thereby allowing the hydraulic fluid flowing through the primary inlet port 202 to flow around the inlet valve member 210 through the primary chamber 201. In the arrangement depicted, the inlet valve member 210 is in the form of a ball, with the primary chamber 201 being cylindrical. The primary chamber 201 typically has a diameter of between 1.1 and 1.5 times the diameter of the inlet valve member 210. In the particular arrangement depicted, the primary chamber 201 has a diameter of 5.5 mm and the inlet valve member 210 has a diameter of 4.5 mm. When the inlet valve member 210 is located centrally, it leaves an annular gap having a width of 0.5 mm between the inlet valve member 210 and the wall 207 of the primary chamber 201. The primary inlet port 202 is here also cylindrical and has a diameter less than the diameter of the inlet valve member 210, here particularly having a diameter of approximately 3.2 mm. In the particular arrangement depicted, an inlet valve spring 211 is located in the primary chamber 201, extending between the inlet stop 203 and the inlet valve member 210. The inlet valve spring 211 is a compression spring and acts to bias the inlet valve member 210 towards the inlet valve seat 203, thereby biasing the inlet valve member 210 to its closed position. The inlet valve spring 211 is mounted on the inlet stop stalk 208.

The inlet valve path is kept relatively short so as to reduce the time taken for the inlet valve member 210 to move between the open and closed positions, whilst still allowing a sufficient clearance between the inlet valve seat 203 and inlet valve member 210, when in its open position, to allow for sufficient flow of hydraulic fluid through the primary inlet port 202. In particular, it is preferred that the inlet valve path has a length of between 0.5 times and 2.0 times the difference in diameters of the primary chamber 201 and the inlet valve member 210. Accordingly, it is preferred that the inlet valve path has a length of between 0.5 mm and 2.0 mm. Typically, the inlet valve path length is approximately equal to the difference in diameters, which, in the particular arrangement depicted, provides an inlet valve path length of approximately 1.0 mm.

A primary outlet port 212 is located at a downstream end of the primary chamber 201. The primary outlet port 212 communicates the primary chamber 201 with the actuable member of the tool, being the second jaw 52. The primary outlet port 212 defines an annular outlet valve seat 213 at the downstream end thereof.

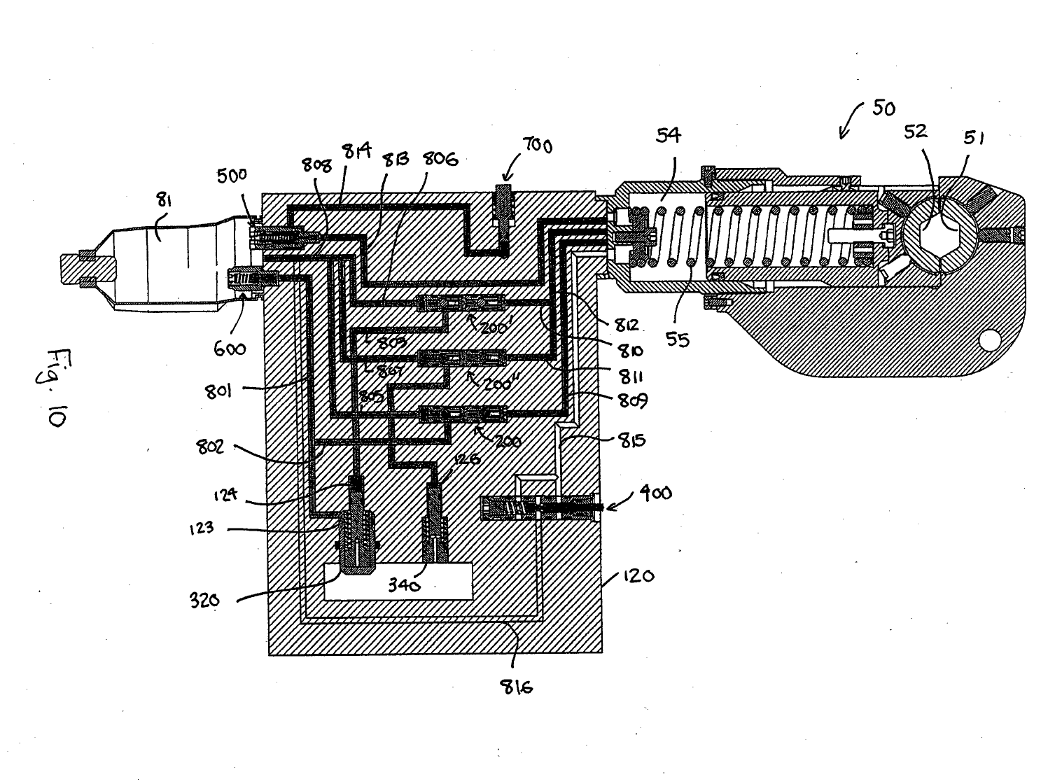

A charging port 214 is located between the primary inlet port 202 and the primary outlet port 212. The charging port 214 communicates the primary chamber 201 with an hydraulic pump, comprising the first piston 321 and first piston chamber 123 in the case of the first shuttle valve assembly 200, the second piston 331 and piston chamber 124 in the case of the second shuttle valve assembly 200′ and the third piston 341 and third piston chamber 126 in the case of the third shuttle valve assembly 200″, as best depicted in FIGS. 9 and 10. In the particular arrangement depicted, there are four charging ports 214 spaced about the wall 207 of the primary chamber 201.

An outlet stop 224 is located downstream of the outlet valve seat 213. The outlet stop 224 is identical to the inlet stop 204, having a cylindrical outlet stop base 225 and cylindrical outlet stop stalk 228 extending upstream from the outlet stop base 225 and defining an outlet stop face 229. An outlet valve member 230 is located between the outlet valve seat 213 and the outlet stop 224. The outlet valve member 230 is displaceable along an outlet valve path between a closed position sealingly engaging the outlet valve seat 213 to at least substantially prevent the flow of hydraulic fluid through the primary outlet port 212, and an open position (depicted in FIG. 8) engaging the outlet stop face 229. In the open position, the outlet valve member 230 allows the flow of hydraulic fluid through the primary outlet port 212. In the arrangement depicted, the outlet valve member 230 is in the form of a ball.

In the depicted embodiment, the outlet stop 224 and outlet valve member 230 are housed within a cylindrical secondary chamber 221, with the outlet stop base 225 being fixed in position within the secondary chamber 221 by way of a shaft 226 extending laterally through the outlet stop base 225 and through opposed sides of the wall 227 of the secondary chamber 221.

The outlet valve member 230 is sized to allow a gap between the outlet valve member 230 and the wall 227 of the secondary chamber 221, thereby allowing the hydraulic fluid flowing through the primary outlet port 212 to flow around the outlet valve member 230 through the secondary chamber 221. The secondary chamber 221 is of identical size and configuration to the primary chamber 201, and the outlet valve member 230 is also of identical size to the inlet valve member 210. Accordingly, the secondary chamber 221 typically has a diameter of between 1.1 and 1.5 times the diameter of the outlet valve member 230 and in the particular arrangement depicted, the secondary chamber 221 has a diameter of 5.5 mm and the outlet valve member 230 has a diameter of 4.5 mm. An annular gap having a width of 0.5 mm is thus left between the outlet valve member 230 and the wall 227 of the secondary chamber 221 when the outlet valve member 230 is located centrally. The primary outlet port 212 is here also cylindrical and is of identical configuration to the primary inlet port 202, having a diameter less than the diameter of the outlet valve member 230 and here particularly having a diameter of approximately 3.2 mm. In the arrangement depicted, an outlet valve spring 231 is located in the secondary chamber 221, extending between the outlet stop 213 and the outlet valve member 230. The outlet valve spring 231 is identical to the inlet valve spring 211, being a compression spring which acts to bias the outlet valve member 230 towards the outlet valve seat 213, thereby biasing the outlet valve member 230 to its closed position. The outlet valve spring 231 is mounted on the outlet stop stalk 228.

As with the inlet valve path, the outlet valve path is kept relatively short so as to reduce the time taken for the valve member 220 to move between the open and closed positions, while still allowing for sufficient flow of hydraulic fluid through the primary outlet port 212. It is again preferred that the outlet valve path has a length of between 0.5 times and 2.0 times the difference in diameters of the secondary chamber 221 and the outlet valve member 230. It is thus preferred that the outlet valve path has a length of between 0.5 mm and 2.0 mm. Typically, the outlet valve path length is approximately equal to the difference in diameters, which, in the particular arrangement depicted, provides an inlet valve path length of approximately 1.0 mm.

Whilst ports 234 identical to the charging ports 214 are provided in the wall 227 of the secondary chamber 221, these have no effect in use as they do not communicate with any components of the crimping tool as will be further discussed below. A secondary outlet port 242 is defined at the downstream end of the secondary chamber 221.

In the arrangement depicted, the shuttle valve assembly 200 comprises a valve body hat defines the primary and secondary chambers 201, 221 and which is housed within a cylindrical cavity 127 defined in the body block 120, as shown in FIGS. 3 to 5. In particular, the valve body of the first shuttle valve assembly 200 is located within a first shuttle valve cavity 127, the valve body of the second shuttle valve assembly 200′ is located in a second shuttle valve cavity 127′ and the valve body of the third shuttle valve assembly 200″ is located within a third shuttle valve cavity 127″.

In the particular configuration depicted, the valve body of the shuttle valve assembly 200 comprises a primary valve cartridge 215 and a secondary valve cartridge 235 that is identical to the primary valve cartridge 215. The primary valve cartridge 215 defines the primary chamber 201 whilst the secondary valve cartridge 235 defines the secondary chamber 221. The upstream end portion of the primary valve cartridge 215 defines the primary inlet port 202. The upstream portion of the secondary valve cartridge 235 defines the primary outlet port 212 and the downstream portion of the secondary valve cartridge 235 defines the secondary outlet port 242. Each of the primary and secondary valve cartridges 215, 235 is provided with a pair of adjacent annular seals 216, 217 and 236, 237 for sealing between the respective valve cartridge 215, 235 and the wall of the shuttle valve cavity 127. Each of the shuttle valve assemblies 200, 200′, 200″ is retained within the respective shuttle valve cavity 127, 127′, 127″ by a retainer 260.

The charging ports 214 are located in a reduced outer diameter section of the primary valve cartridge 215 which defines, with the wall of the shuttle valve cavity 127, an annular void which allows each of the charging ports 214 to communicate with a respective charging line 802, 803, 804 as discussed below. The ports 234 are also formed in a reduced diameter portion of the secondary valve cartridge 235 and thus communicate with a further void defined between the secondary valve cartridge 235 and the wall of the shuttle valve cavity 127. This further void, however, does not communicate with any hydraulic lines and the further ports 234 are thus redundant, only being present by virtue of the fact that the secondary valve cartridge 235 is identical to the primary valve cartridge 215.

The hydraulic circuits of the hydraulic crimping tool, and operative relationship between components thereof, is schematically depicted in FIGS. 9 and 10. FIG. 9 depicts the tool at commencement of the crimping operation, whilst FIG. 10 depicts the tool at completion of the crimping operation. The block body 120 defines a series of hydraulic pressure lines that operatively communicate various components of the crimping tool. A low pressure relief line 801 communicates the first piston chamber 123 with the hydraulic fluid supply 81 via the low pressure relief valve assembly 600.

A low pressure charging line 802 communicates the first piston chamber 123 with the charging ports 214 of the first shuttle valve assembly 200. In the arrangement depicted, the low pressure charging line 802 branches from the low pressure relief line 801. A first high pressure charging line 803 communicates the second piston chamber 124 with the second shuttle valve assembly 200′. A second high pressure charging line 804 communicates the second piston chamber 124 with the charging ports 214 of the third shuttle valve 200″.

A first supply line 805 communicates the hydraulic pressure supply 81 with the primary inlet port 202 of the first shuttle valve assembly 200. A second supply line 806 communicates the hydraulic pressure supply 81 with the primary inlet port 202 of the second shuttle valve assembly 200′. A third supply line 807 communicates the hydraulic pressure supply 81 with the primary inlet port 202 of the third shuttle valve assembly 200″. In the arrangement depicted, the first, second and third supply lines 805, 806, 807 branch off a primary supply line 808 which communicates directly with the hydraulic fluid supply 81.

A low pressure actuation line 809 communicates the secondary outlet port 242 (and, indirectly, the primary outlet port 212) of the first shuttle valve assembly 200 with a head chamber 54 defined in the head assembly 50. A first high pressure actuation line 810 communicates the secondary outlet port 242 (and, indirectly, the primary outlet port 212) of the second shuttle valve assembly 200′ with the head chamber 54. A second high pressure actuation line 811 communicates the secondary outlet port 242 (and, indirectly, the primary outlet port 212) of the third shuttle valve assembly 200″ with the head chamber 54. The first and second high pressure actuation lines 810, 811 branch off a primary high pressure actuation line 812 which communicates directly with the head chamber 54.

A high pressure relief line 813 communicates the head chamber 54 with the hydraulic fluid supply 81 via the high pressure relief valve assembly 500. An indicator line 814 communicates the high pressure relief valve assembly 500 with the indicator assembly 700. A first return line 815 communicates the head chamber 54 with the head pressure return valve assembly 400. A second return line 816 communicates the head pressure return valve assembly 400 with the hydraulic fluid supply 81 via the primary supply line 808.

Operation of the hydraulic crimping tool will now be described with particular reference to FIGS. 3, 9 and 10. The connector or splice to be crimped is firstly located within the recess 53 defined between the first and second opposing jaws 51, 52. A jaw return spring 55, in the form of a tension spring, is mounted between an end wall of the head chamber 54 and the second jaw 52 to bias the second jaw 52 to the open position depicted in FIG. 9, allowing location of the connector or splice in the recess 53.

The hydraulic crimping tool is then operated by depressing the operating trigger 14, which results in electrical power provided by the battery pack 20 powering the motor and gearbox assembly 70, which in turn rotatably drives the crankshaft 312. Resultant rotation of the crankshaft 312 provides reciprocating motion of the first and second piston assemblies 320, 340. The first and second cam lobes 313, 314 are configured with opposing geometries, here with the nose (i.e. the highest part of the lobe) of each cam lobe 313, 314 separated by 180 degrees, such that the first and second piston assemblies 320, 340 reciprocate in opposing phases.

Rotation of the first cam lobe 313 results in the first and second pistons 321, 331 reciprocating in unison by contact of the first cam follower face 323 with the first cam lobe 313 and the action of the first spring 328, which keeps the first cam follower face 323 in contact with the first cam lobe 313. The first and second pistons 321, 331 reciprocate within the first and second piston chambers 123, 124 respectively, between discharge and suction cycles of the dual first pump defined by the first piston assembly 320 and first piston mounting cavity 122. In the discharge cycle, the first piston assembly 320 extends into the piston mounting cavity 122, thereby increasing pressure in the first and second piston chambers 123, 124. In the suction cycle, the first piston assembly 320 is retracted from the first piston mounting cavity 122, thereby reducing pressure in the first and second piston chambers 123, 124.

Rotation of the second cam lobe 314 results in the third pistons 341 reciprocating by contact of the second cam follower face 343 with the second cam lobe 314 and the action of the second spring 338, which keeps the second cam follower face 343 in contact with the second cam lobe 314. The third piston 341 reciprocates within the third piston chamber 126 between discharge and suction cycles of the second pump defined by the second piston assembly 340 and second piston mounting cavity 125. In the discharge cycle, the second piston assembly 340 extends into the second piston mounting cavity 125, thereby increasing pressure in the third piston chamber 126. In the suction cycle, the second piston assembly 340 is retracted from the second piston mounting cavity 125, thereby reducing pressure in the third piston chamber 126. Due to the offset axes of the first and second cam lobes 313, 314, whilst the first piston assembly 320 is in the discharge cycle, the second piston assembly 340 is in the suction cycle and vice versa. This assists in balancing the load on the motor and gearbox assembly 70 and improves smoothness of operation.

At commencement of operation, whilst the first and second jaws 51, 52 are separated, no load is applied to the actuable second jaw 52.

During the discharge cycle of the first piston assembly 320, pressure within the first piston chamber 123 increases, driving hydraulic fluid in the first piston chamber 123 through the low pressure charging line 802 (via the low pressure relief line 801) into the primary chamber 201 of the first shuttle valve assembly 200, thereby increasing the pressure in the primary chamber 201. The hydraulic fluid driven from the first piston chamber 123 along the low pressure relief line 801 also acts on the low pressure relief valve assembly 600. The low pressure relief valve assembly 600 is, however, spring biased to a sealed configuration, adapted only to open when pressure in the low pressure relief line 801 reaches a predetermined low pressure threshold. The predetermined low pressure threshold is set slightly higher than the pressure exerted by the jaw return spring 55 at full extension, against which the pressure within the head chamber 54 (which is directly related and substantially identical to, the pressure in the low pressure relief line 801) must act to displace the second jaw 52 towards the splice or connector located in the recess 53 during the initial high-volume low pressure phase of operation. The predetermined low pressure threshold is factory adjustable by a screw adjuster applying pressure against the internal biasing spring of the low pressure relief valve assembly 600. A lock nut locks the screw adjuster in place once the correct low pressure threshold has been set.

Referring now to FIG. 8, depicting the first shuttle valve assembly 200, the increased pressure in the primary chamber 201, during the discharge cycle of the first piston assembly 320 will, together with the inlet valve spring 211, drive the inlet valve member 210 along the inlet valve path, into its closed position against the inlet valve seat 203, thereby sealing the primary inlet port 202. The limited length of the inlet valve path between the inlet valve seat 203 and inlet stop ensures rapid displacement of the inlet valve member 210 into its closed position, greatly limiting backflow of hydraulic fluid from the primary chamber 201 back to the hydraulic fluid supply and associated pressure loss. As pressure in the primary chamber 201 increases beyond the pressure in the head chamber 54 during the discharge cycle, the pressure in the primary chamber 201 will act on the outlet valve member 230 against the outlet valve spring 231 and pressure in the head chamber 54 to drive the outlet valve member 230 to its open position against the outlet stop 224. This allows the hydraulic fluid at increased pressure in the primary chamber 201 to be driven at the increased pressure out of the primary outlet port 252 and secondary outlet port 242, and through the low pressure actuation line 809 to the head chamber 54, thereby increasing pressure in the head chamber 54. The increasing pressure in the head chamber 54 will then act to displace the second jaw 52 towards the first jaw 51, against the biasing return force of the jaw return spring 55.

In the suction cycle of the first piston assembly 320, the pressure in the first piston chamber 123 reduces, drawing hydraulic fluid at reduced pressure back from the primary chamber 201 of the first shuttle valve assembly 200, through the low pressure charging line 802 back into the first piston chamber 123. When the pressure within the primary chamber 201 reduces sufficiently for pressure within the hydraulic fluid supply 81 (which would typically be at atmospheric pressure) to overcome the reduced pressure in the primary chamber 201 and the inlet valve spring 211, the inlet valve member 210 is driven along the inlet valve path from its closed position, seated against the primary inlet valve 203, to its open position against the inlet stop 204. The limited travel of the inlet valve member 210 along the inlet valve path between the inlet valve seat 203 and inlet stop 204 again ensures that the movement of the inlet valve member 210 between its open and closed positions is rapid. With the inlet valve member 210 in its open position, hydraulic fluid is drawn from the hydraulic fluid supply 81 through the first supply line (via the primary supply line 808) into the low pressure primary chamber 201. The reduced pressure in the primary chamber 201 during the suction cycle also allows the higher pressure in the head chamber 84 and the outlet valve spring 231 to drive the outlet valve member 230 along the outlet valve path from the outlet stop 224 to its closed position against the outlet valve seat 213, sealing the primary valve outlet 212. Again, the limited length of the outlet valve path ensures rapid displacement of the outlet valve member 230 into its closed position, greatly limiting backflow of hydraulic fluid from the head chamber 54 into the primary chamber 201 and associated pressure loss.

With each successive discharge and suction cycle, the pressure in the head chamber 54 increases, with further hydraulic fluid being supplied from the hydraulic fluid supply 81 during each suction cycle. With the pressure in the head chamber 54 increasing in each successive discharge cycle, the pressure in the primary chamber 201 also increases with each cycle, resulting in a corresponding pressure increase in the low pressure relief line 801. When the pressure in the low pressure relief line 801 reaches the predetermined low pressure threshold, which will generally be set to occur as soon as, or immediately after, the second jaw 52 (and first jaw 51) engages the splice or connector, the low pressure relief valve assembly 600 opens, thereby relieving pressure in the low pressure charging line 802 and primary chamber 201, equalizing it with the (typically atmospheric) pressure in the hydraulic fluid supply 81 and first supply line 805. The first shuttle valve assembly 200 thus ceases its operation once this threshold pressure has been attained. This signifies the end of the high-volume, low pressure initial phase of operation during which the second jaw 52 will be rapidly displaced towards the first jaw 51 until the gap therebetween is reduced sufficiently to have the connector or splice contacted by both jaws 51, 52, at which point the jaw pressure required to further displace the second jaw 52 is greatly increased, as the connector/splice is crushed between the jaws 51, 52. It is primarily the relatively large effective cross-sectional area of the first piston chamber 123 that provides for the initial rapid displacement of the second jaw 52, given the resultant high hydraulic fluid flow rate during each discharge cycle of the first piston 321.

As the first piston assembly 320 reciprocates through each discharge and suction cycle as described above, pressure within the second piston chamber 124 increases and decreases in phase with the pressure increase and decrease in the first piston chamber 123. Accordingly, during each discharge cycle of the first piston assembly 320, pressure within the second piston chamber 124 increases, driving hydraulic fluid in the second piston chamber 124 through the first high pressure charging line 803 into the primary chamber 201 of the second shuttle valve assembly 200′, thereby increasing the pressure in the primary chamber 201′. The second shuttle valve assembly 200′ will thus operate in the same manner as the first shuttle valve assembly 200, driving the hydraulic fluid at increased pressure out of the primary outlet port 212 and secondary outlet port 242 of the second shuttle valve assembly 200′, through the first high pressure actuation line 810 to the head chamber 54, thereby again increasing pressure in the head chamber 54. Accordingly, during the discharge cycle of the first piston assembly 320, both the first and second pistons 321, 331 act to increase the pressure in the head chamber 54, acting to displace the second jaw 52 towards the first jaw 51.

In each suction cycle of the first piston assembly 320, the pressure in the second piston chamber 124 reduces, drawing hydraulic fluid at reduced pressure back from the primary chamber 201 of the second shuttle valve assembly 200′ through the first high pressure charging line 803 back into the second piston chamber 124. This again results in hydraulic fluid being drawn from the hydraulic fluid supply 81, through the second supply line 802 into the low pressure primary chamber 201 of the second shuttle valve assembly 200′.

The second piston 331 and second shuttle valve assembly 200′ continue to operate in unison with the first piston 321 and first shuttle valve assembly 200 as pressure in the head chamber 54 increases. Whilst still in operation prior to activation of the low pressure relief valve 600, the first piston 321 and first shuttle valve assembly 200 are), the first pump (defined by the first piston 321 and first piston chamber 123) provide a much greater hydraulic fluid flow rate than the second pump (defined by the second piston 321 and second piston chamber 124) and second shuttle valve assembly 200′, given the greater effective cross-sectional area of the first piston chamber 123. After the low pressure relief valve 600 has opened, signaling the end of the high-volume low pressure initial phase of operation, the second pump assembly and the second shuttle valve assembly 200′ continue to operate to continue increasing pressure within the head chamber 54, albeit at a slower rate.

Arranging the first and second pistons 321, 331 in a single first piston assembly 320 providing a dual phase pump arrangement with a high volume, low pressure pump assembly and low volume, high pressure pump assembly allows the overall pump assembly 300 to be kept relatively compact and provides the benefit of rapid displacement of the second jaw 52 and the low pressure in the initial phase of operation to bring the first and second jaws 51, 52 into contact with the connector/splice to be crimped followed by a final stage of operation allowing crushing of the connector/splice under high pressure.

Throughout operation of the first piston assembly 320, the second piston assembly 340 also reciprocates through successive discharge and suction cycles, 180 degrees out of phase with the first piston assembly 320 as noted above. As the second piston assembly 340 reciprocates through its discharge and suction cycles, pressure within the third piston chamber 126 increases and decreases (out of phase with the pressure increase and decrease in the first and second piston chambers 123, 124). During each discharge cycle of the second piston assembly 340, pressure within the third piston chamber 126 increases, driving hydraulic fluid in the third piston chamber 126 through the second high pressure charging line 804 into the primary chamber 201 of the third shuttle valve assembly 200″, thereby increasing the pressure in the primary chamber 201. The third shuttle valve assembly 200′ operates in the same manner as the first and second shuttle valve assemblies 200, 200′, driving the hydraulic fluid at increased pressure out of the primary outlet port 212 and secondary outlet port 242 of the third shuttle valve assembly 200′, through the second high pressure actuation line 811 to the head chamber 54, increasing pressure in the head chamber 54. This occurs, however, out of phase with the first and second shuttle valve assemblies 200, 200′ whilst the primary outlet ports 212 of the first and second shuttle valve assemblies 200, 200′ are sealed.

During each suction cycle of the second piston assembly 340, the pressure in the third piston chamber 126 reduces, drawing hydraulic fluid at reduced pressure back from the primary chamber 201 of the third shuttle valve assembly 200″ through the second high pressure charging line 804 back into the third piston chamber 126. This again results in hydraulic fluid being drawn from the hydraulic fluid supply 81, through the third supply line 803 into the low pressure primary chamber 201 of the third shuttle valve assembly 200″.

Operation of the second pump (defined by the third piston 341 and third piston chamber 126), out of phase with the first pump, effectively doubles the rate of displacement of the second jaw 52 during the final phase of operation, thereby effectively doubling the crushing rate of the crimp/splice and halving the time taken for the final phase of operation, as compared to utilizing a single low volume, high pressure pump assembly only.

Throughout operation, the increase in pressure in the head chamber 54 increases fluid pressure in the high pressure relief line 813. The high pressure relief valve assembly 500 is biased under spring pressure into a closed position, isolating the high pressure relief line 813 from the hydraulic fluid supply 81 and the indicator line 814. The high pressure relief valve assembly 500 is configured to open once a predetermined high pressure has been reached in the high pressure relief line 813 (and head chamber 54), correlating to the crimp pressure applied between the first and second jaws 51, 52 required for forming an adequate crimp or splice. This will typically be of the order of 10,000 psi (about 70 mPa). The predetermined high pressure is factory adjustable by a screw adjuster applying pressure against the internal biasing spring of the high pressure relief valve assembly 500. A lock nut locks the screw adjuster in place once the correct high pressure has been set.

Once the predetermined high pressure is achieved, the high pressure relief valve assembly 500 opens. This communicates the high pressure relief line 813 with the indicator line 814. The pressure in the indicator line 814 acts against the spring 702, activating the indicator valve assembly 700, to extend the indicator body 701 into a visible position protruding from the opening 121 in the top of the body block 120 as depicted in FIG. 10. This provides the operator with a visual indication that the crimping operation is complete. Opening of the high pressure relief valve assembly 500 also communicates the high pressure relief line 813 with the hydraulic fluid supply 81, thereby venting the pressure in the head chamber 54 to the hydraulic fluid supply, which will typically be at atmospheric pressure. Sufficient back pressure is initially retained within the high pressure relief valve assembly 500 to provide sufficient pressure in the indicator line 814 to activate the indicator assembly 700, indicating to the operator that the crimping operation is complete, prompting the operator to release the operating trigger 14 removing power from the motor and gearbox assembly 701. As pressure in the head chamber 54, high pressure relief line 813 and relief line 814 continues to vent to the hydraulic fluid supply 81, the spring 702 retracts the indicator body 701. With the crimping operation complete and pressure relieved in the head chamber 54, the return spring 55 retracts the second jaw 52, enabling removal of the completed crimp or splice from between the first and second jaws 51, 52.

At any time during the crimping operation, the operation may be ceased and pressure within the head assembly relieved by depressing a release trigger 15, mounted above the operating trigger 14. The release trigger 15 which in turn operates the head pressure return valve assembly 400, communicating the head chamber 54 with the hydraulic fluid supply 81 via the first return line 815, head pressure return valve assembly 400, second return line 816 and primary supply line 808. The pressure within the head chamber 54 is thus released, allowing the crimping operation to be aborted.

It is envisaged that the shuttle valve arrangement described above may be utilized with other forms of hydraulically actuated tools, other than hydraulic crimping tools. It is also envisaged that the shuttle valve assembly 200 may be utilized with other forms of pump assembly in such hydraulically actuated tools, including in tools with a single one phase piston arrangement or single dual phase piston arrangement. It is further envisaged that the pump assembly 300 described above may be utilized in conjunction with other forms of valve assembly for actuating the head of hydraulic crimping tools or other hydraulically actuated tools. A person skilled in the art will also appreciate various other possible modifications to the arrangements described.

1-16. (canceled)

17. An hydraulically actuated tool comprising:
a) an hydraulic fluid supply;
b) a first pump operable in reciprocating suction and discharge cycles, said first pump having:
i) a first piston chamber;
ii) a second piston chamber;
iii) a first piston assembly having a first piston mounted for reciprocating motion within said first piston chamber and a second piston mounted for reciprocating motion within said second piston chamber in unison with said first piston during said suction and discharge cycles of said first pump;
c) a second pump operable in reciprocating suction and discharge cycles, said second pump having:
i) a third piston chamber; and
ii) a second piston assembly having a third piston mounted for reciprocating motion within said third piston chamber during said suction and discharge cycles of said second pump;
d) a drive motor operable to drive said first, second and third pistons;
e) a head chamber;
f) an actuable member adapted to be actuated by pressure within said head chamber;
g) a first valve assembly operatively associated with said first piston such that, during an initial phase of operation of said tool, said first piston draws hydraulic fluid from said hydraulic fluid supply during said suction cycle of said first pump and drives hydraulic fluid into said head chamber during said discharge cycle of said first pump;
h) a second valve assembly operatively associated with said second piston such that said second piston draws hydraulic fluid from said hydraulic fluid supply during said suction cycle of said first pump and drives hydraulic fluid into said head chamber during said discharge cycle of said first pump;
i) a third valve assembly operatively associated with said third piston such that said third piston draws hydraulic fluid from said hydraulic fluid supply during said suction cycle of said second pump and drives hydraulic fluid into said head chamber during said discharge cycle of said second pump;
j) a low pressure relief valve adapted to communicate said first piston chamber with said hydraulic fluid supply upon pressure within said first valve assembly reaching a predetermined threshold pressure, thereby ending said initial phase of operation;
wherein said first piston chamber has a larger effective cross-sectional area than an effective cross-sectional area of each of said second and third piston chambers.

18. The tool of claim 17, wherein said first and second pumps are adapted to operate out of phase in opposing cycles.

19. The tool of claim 17, wherein at least one of said valve assemblies is a shuttle valve assembly comprising:
a primary chamber;
a primary inlet port located at an upstream end of said primary chamber for communicating said primary chamber with an hydraulic fluid supply, said primary inlet port defining an inlet valve seat at a downstream end thereof;
an inlet stop located in said primary chamber downstream of said inlet valve seat;
an inlet valve member located between said inlet valve seat and said inlet stop, said inlet valve member being displaceable along an inlet valve path between a closed position sealingly engaging said inlet valve seat to at least substantially prevent flow of hydraulic fluid through said primary port and an open position engaging said inlet stop and allowing flow of hydraulic fluid through said primary inlet port and around said inlet valve member through said primary chamber;
a primary outlet port located at a downstream end of said primary chamber for communicating said primary chamber with an actuable member of the tool, said primary outlet port defining an outlet valve seat at a downstream end thereof;
an outlet stop located downstream of said outlet valve seat;
an outlet valve member located between said outlet valve seat and said outlet stop, said outlet valve member being displaceable along an outlet valve path between a closed position sealingly engaging said outlet valve seat to at least substantially prevent flow of hydraulic fluid through said primary outlet port and an open position engaging said outlet stop and allowing flow of hydraulic fluid through said primary outlet port and around said outlet valve member towards the actuable member; and
a charging port located between said primary inlet port and said primary outlet port for communicating said primary chamber with an hydraulic pump.

20. The tool of claim 19, wherein each of said valve assemblies is a said shuttle valve assembly.

21. The tool of claim 17, wherein said effective cross-sectional area of said second piston chamber is substantially equal to said effective cross-sectional area of said third piston chamber.

22. The tool of claim 17, wherein said effective cross-sectional area of said first piston chamber is at least four times said effective cross-sectional area of said third piston chamber.

23. The tool of claim 17, wherein said first piston chamber and said second piston chamber are together defined by a first piston mounting cavity formed in said body.

24. The tool of claim 17, wherein
said first piston comprises a first piston base and an annular first piston body extending from said first piston base; and
said second piston comprises a second piston base received in said recess and a cylindrical piston body extending from said second piston base into said second piston chamber.

25. The tool of claim 17, wherein said first pump further comprises a spring bearing against said second piston base.

26. The tool of claim 17, further comprising a cam shaft assembly comprising:
a rotatable shaft driveable by said drive motor;
a first cam lobe mounted on said shaft and engaging a cam follower face of said first pump to drive said first and second pistons; and
a second cam lobe mounted on said shaft and engaging a cam follower face of said second piston for driving said second piston.

27. The tool of claim 17, wherein said tool is a crimping tool.
